(19) United States
(12) Patent Application Publication
(10) Pub. No.: US 2005/0216621 A1
(43) Pub. Date: Sep. 29, 2005

(54) SPI-module and method for reading out data from an SPI module

(76) Inventor: Leo Aichriedler, Ebersberg (DE)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 11/012,633

(22) Filed: Dec. 15, 2004

(30) Foreign Application Priority Data
Dec. 16, 2003 (DE) DE103 58 974.0-53

(51) Int. Cl. G06F 13/38

(52) U.S. Cl. 710/62

(57) ABSTRACT

The invention relates to a serial/parallel interface module (SPI module) (10), which has a plurality of parallel inputs (111-11n) for supplying data (SD1-SDn), a memory arrangement (11) for storing supplied data, a serial command input (DI) and a serial data output (DO), the SPI module (10) providing a plurality of data blocks of a predetermined length in direct succession at the serial output (DO) upon receipt of a read signal of a first type. The invention also relates to a method for reading out data from an SPI module.

The present invention relates to a serial/parallel interface module (SPI module) and to a method for reading out data from such a module.

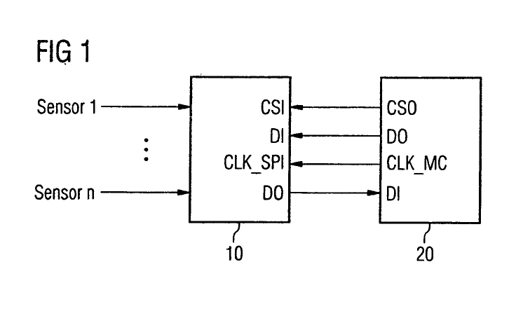

SPI modules of this type are generally known and are used, for example, in occupant protection systems of motor vehicles, as is explained with reference to FIG. 1.

In the case of such systems, a plurality of sensors are connected to parallel inputs of the SPI module 10, said sensors providing sensor data (which are stored in the SPI module) at regular intervals of time. These stored sensor data are read out by a microcontroller 20, which is connected to the SPI module, evaluates the sensor data and, in the event of an accident that is detected using the sensor data, triggers the occupant protection system, for example an airbag or a seatbelt pretensioner. The sensor data are, for example, pressure or acceleration data which can be used to detect an accident.

The data stored in the SPI module are read out serially via a data output DO of the SPI module 10, which is connected to a data input DI of the microcontroller 20. The SPI module 10 also has a chip select input CSI, which is connected to a chip select output CSO of the microcontroller 20, a command input DI, which is connected to a data output DO of the microcontroller 20, and a clock input CLK_SPI, which is connected to a corresponding clock output CLK_MC of the microcontroller 20.

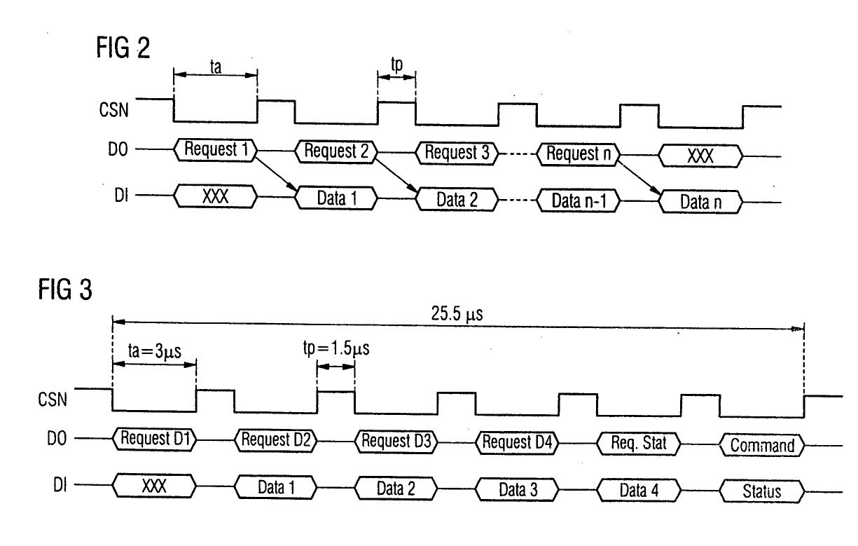

Referring to FIG. 2, the microcontroller 20 sends a request to the data input DI of the SPI module in order to read out the sensor data from the SPI module 10, the request specifying the sensor whose data are intended to be read out. The SPI module is activated, both to receive a request and to output the data via its data output DO, by means of a chip select signal at its chip select input CSI, said chip select signal assuming a low level in the example illustrated in order to activate the module 10. In order to read out data, a request is sent to the SPI module 10 during a first activation period ta (which is also referred to as the frame time) and the data which have been read out are output to the microcontroller 20 during a next activation period ta. In this case, the activation period ta is constant and is, for example, selected in such a manner that, during the activation period, it is possible to transmit data blocks having a length of 8, 10 or 16 bits depending on the concrete implementation.

It is necessary to observe an activation pause tp (which is also referred to as the inter-frame time) between the individual operations of activating the SPI module, as a result of which it is not possible for the data which have been read out to be output to the microcontroller 20 immediately—in terms of time—after the request. These activation pauses contribute considerably to the total transmission duration, as will be explained below with reference to FIG. 3. In this example, activation periods ta having a length of 3 μs and activation pauses tp having a length of 1.5 μs are respectively assumed. In order to read an SPI module having four data registers, to which connected sensors write, and one status register, which contains status information for the SPI module, 25.5 μs are required in this case if, when reading out a data block or reading a register, the request to read the next register is simultaneously sent to the SPI module. In this case, 7.5 μs and thus 29.4% of the total read-out duration are apportioned to the activation pauses of the SPI module.

As the complexity of occupant protection systems increases, the number of sensors used and thus also the number of memories or registers containing sensor data which are to be regularly read out from the SPI module increase. Despite the increasing amount of data, the data processing duration that also comprises reading out the sensor data from the SPI register should, however, be as short as possible.

It is an aim of the present invention to provide an SPI module, which makes it possible to read out, in a temporally optimized manner, data stored therein, and a method for reading an SPI module in an optimized manner.

This aim is achieved by means of an SPI module in accordance with the features of claim 1. The subclaims relate to advantageous refinements of the invention.

The SPI module comprises a plurality of parallel inputs for supplying data, a memory arrangement for storing supplied data in data blocks, a serial command input and a serial data output. The SPI module is designed to provide a plurality of data blocks in direct succession at the serial output upon receipt of a read signal of a first type.

Instead of a separate read command for each data block, one read command of the first type suffices, in the SPI module according to the invention, to output a plurality of data blocks in direct succession. An SPI module of this type is particularly suited to occupant protection systems in motor vehicles having a multiplicity of sensors whose data are supplied, at regular intervals of time, to an evaluation circuit or a microcontroller for the purposes of evaluation. The data from these sensors are stored in a conventional manner in the SPI module in registers provided for this purpose, the registers, unlike conventional SPI modules, not being read individually but rather together, with the result that a data sequence whose length corresponds to the length of one data block multiplied by the number of data blocks which have been read out is provided at the output of the SPI module.

The SPI module is preferably designed to provide one individual data block at its output in a conventional manner upon receipt of a read signal of a second type.

In the module according to the invention, only one activation pause occurs during the read-out operation following receipt of the read signal of the first type, as a result of which the total read-out duration is considerably reduced in comparison with conventional SPI modules.

In one embodiment, provision is made for the SPI module to have a separate input for supplying the read signal of the first type and to be designed to immediately provide the successive data blocks at the serial output upon receipt of such a read signal. This makes it possible to reduce the read-out duration further.

In the case of the SPI module, the number of data blocks which are output in direct succession can preferably be set by means of the read signal of the first type.

The present invention is explained in more detail below with reference to figures.

FIG. 1 shows a circuit arrangement having an SPI module and a microcontroller.

FIGS. 2 and 3 illustrate the temporal profile of read-out operations in an SPI module in accordance with the prior art.

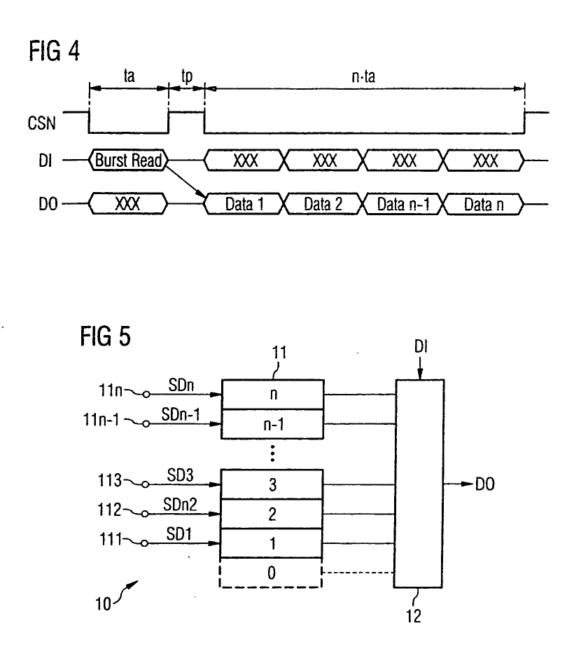

FIG. 4 illustrates the temporal profile of a read-out operation in an SPI module according to the invention.

FIG. 5 diagrammatically shows the structure of an SPI module in order to explain a read-out operation.

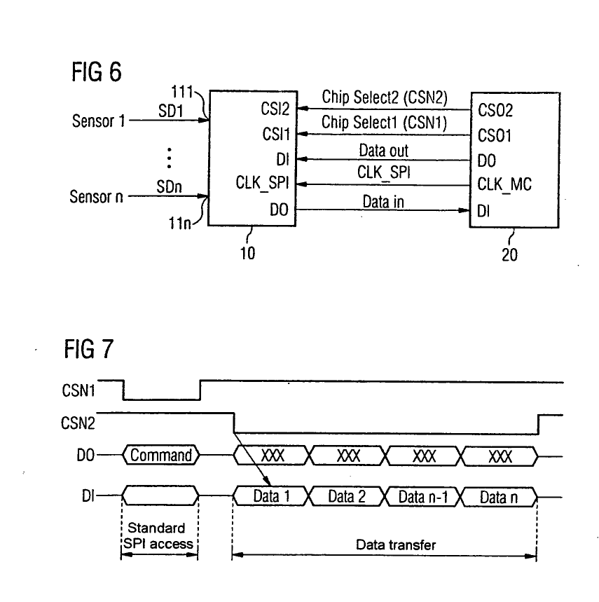

FIG. 6 shows a circuit arrangement having an SPI module in accordance with a further embodiment of the invention, said module having a separate input for supplying a read signal of the first type, and having a microcontroller.

FIG. 7 illustrates a read-out operation in an SPI module in accordance with the further exemplary embodiment.

In the figures, unless specified otherwise, identical reference symbols designate identical parts with the same meaning.

FIG. 4 illustrates a read-out operation in an SPI module according to the invention, which is designed to provide a plurality of data blocks in direct succession at the serial output upon receipt of a read signal of a first type. The terminals which are present in such an SPI module correspond to those in the module illustrated in FIG. 1. The external connection of this module to sensors and a microcontroller also corresponds to that illustrated in FIG. 1.

Referring to FIG. 4, the SPI module receives a read signal of the first type during a first activation period ta, said read signal being referred to as a burst read signal below. After an activation pause tp, the SPI module outputs n data blocks in direct succession at its data output DO, a data block corresponding to the data received from a source, for example a sensor.

In this case, it is possible, in response to the burst read signal, to successively output all of the data blocks stored in the SPI module, which is expedient, in particular, when all of the data stored in the SPI module must be read out at least once at periodic intervals of time. However, it is also possible for the burst read signal to be configured in such a manner that it comprises information relating to the data blocks which are to be output in succession, as a result of which, in response to a burst read signal, only the selected data blocks are provided in direct succession at the data output DO.

Whereas, in conventional SPI modules, it is necessary to observe an activation pause before reading out each data block, only one activation pause occurs, in the SPI module according to the invention, between the receipt of the burst read signal and the beginning of the read-out operation in the case of a burst read operation in which n data blocks are read out, as a result of which the read-out duration can be considerably reduced. In comparison with the example illustrated in FIG. 3, for a data block length of 3 μs and an activation pause of 1.5 μs, the total read-out duration comprising the transmission of the burst read signal, the activation pause and the transmission of five data blocks (the contents of four data registers and one status register) is only 19.5 μs compared with 25.5 μs in the conventional system.

In order to improve understanding, FIG. 5 diagrammatically shows the internal structure of an SPI module, which has a memory 11 and an evaluation circuit 12 that is connected to the memory 11. The memory 11 comprises a plurality of registers which are designated 1 to n and are each assigned to sensors which can be connected to inputs 111-11n of the SPI module. Sensor data SD1-SDn are supplied to the individual registers 1-n via said inputs 111-11n and are stored in the respective register 1-n. The sensor data SD1-SDn are usually supplied to the SPI module 10 at regular intervals of time by the sensors, it being necessary to ensure that the sensor data stored in the registers 1-n are read out, for the purpose of further processing in a microcontroller 20, before the data stored in the registers 1-n are overwritten with new sensor data.

The read-out circuit 12 is connected to the data input DI of the SPI module in order to receive read-out commands. When a burst read signal is received via the data input DI, the read-out circuit 12 reads, in direct succession, the registers 1-n which are connected to it and provides the data output DO with the data which have been read out, for the purpose of further processing in a microcontroller.

The SPI module 10 is preferably also designed to process conventional read commands which each specify one of the data registers 1-n in order to read out only the contents of one of the data registers and provide them at the data output DO.

The SPI module 10 may be designed in such a manner that, upon receipt of the burst read signal, all of the data registers 1-n, including a status register 0, if appropriate, are read. The read-out circuit 12 is preferably designed to interpret burst read signals which specify selected data registers whose contents are intended to be provided in direct succession at the data output DO. It is thus possible to provide a burst read command that specifies the address of an initial register and a number of data registers to be read starting from this initial register. It is furthermore possible to provide a burst read command that specifies the addresses of individual data registers to be read in direct succession.

A microcontroller, for example, provides the SPI module with the burst read command in the manner explained, the data which are output by the SPI module in response to the burst command being processed further by the microcontroller. Referring to FIG. 4, this microcontroller 20 must be designed to activate the SPI module 10 for an extended activation period in response to a burst read command, said extended activation period for reading out n data blocks corresponding to n times one activation period ta.

In a further embodiment of the SPI module according to the invention, provision is made for the burst read signal to be supplied to the SPI module via a separate input, as will be explained below in FIG. 6. FIG. 6 shows such an SPI module in a circuit arrangement having a microcontroller 20, which drives the SPI module 10. The SPI module 10 has a number of parallel inputs 111-11n via which sensor data SD1ₙ, SDn can be supplied to the SPI module.

The SPI module 10 has, in addition to a data output DO, a clock input CLK_SPI and, in addition to a command input DI, a first chip select input CSI1 and a second chip select input CSI2. In this case, the first chip select input CSI1 corresponds to the chip select input of a conventional SPI module 10 and is used to activate the SPI module 10 in the case of conventional read commands which, in connection with the present explanation, correspond to the read commands of the second type.

The second chip select input CSI2 is used as a signal input for the read command of the first type, that is to say the burst read command.

The functioning of this SPI module will be explained below with reference to FIG. 7.

In the left-hand part, FIG. 7 shows the signal profiles in the case of conventional read operations, the second chip select input CSI2 being held at a high level during these conventional read commands, by means of a suitable signal provided by the microcontroller 20, in order to deactivate this second chip select input CSI2. In the manner already explained, the first chip select input CSI1 is respectively activated for one activation period ta in order to supply a read command or to output a data block, for which purpose a low level is applied to this first chip select input during this activation period ta.

The SPI module 10 interprets a low level at the second chip select input CSI2 as a burst read command, in response to which the SPI module 10 provides n data blocks in direct succession at the data output DO.

Irrespective of the concrete implementation of the burst read command, the SPI module according to the invention makes it possible to read out, in a more rapid manner, the data which are provided by sensors and are stored in the module.

In addition to reading out, in a more rapid manner, the data which are stored in the SPI module, the read-out operation explained—in which a plurality of data blocks are output in direct succession in response to the burst read command—also reduces the computational complexity in a microcontroller connected to the SPI module and facilitates improved utilization of the computing power of the microcontroller.

In this respect, the conventional transmission method shown in FIGS. 2 and 3 shall be considered first of all. During the actual data transmission, that is to say during the transmission of the commands to the SPI module 10 and during the reception of data from the SPI module 10, the microcontroller 20 can perform parallel computation tasks. During the activation pauses tp, the microcontroller 20 prepares for communication with the SPI module 10 and is thus not available for parallel computation tasks. In this case, it is additionally necessary to take account of a changeover duration that is required in the microcontroller 20 in order to change over from the parallel computation tasks to communication with the SPI module 10. The example in FIG. 3, in which six data blocks are transmitted over a read-out duration of 25.5 μs, shall be considered. Assuming that the time duration required by the microcontroller in order to change over from communication with the SPI module to parallel computation tasks is 400 nm, the microcontroller is available for parallel computation tasks for 2.2 μs (=3 μs−2·0.4 μs) during each data block that is being read out, that is to say is available for parallel computation tasks only for 13.2 μs over the total duration of 25.5 μs, while the remaining 12.3 μs are needed for communication with the SPI module or for changing tasks.

If a read operation according to the invention as shown in FIG. 4 is considered for n=5 and it is assumed that the duration for transmitting a data block is 3 μs and the activation pause is 1.5 μs, the total transmission duration of this read-out operation is 19.5 μs, as explained. Taking into account a task changeover duration of 400 ns, the microcontroller is available for parallel tasks for 2.2 ns during the transmission of the burst read command and is available for parallel computation tasks for 14.2 μs (=5·3 μs−2·0.4 μs) during the subsequent transmission of the data block. Overall, the microcontroller is thus available for parallel computation tasks for 16.4 μs over the relatively short transmission duration of 19.5 μs. Communication with the SPI module, including the changeover duration, amounts to only 3.1 μs in this case, corresponding to a reduction of approximately 75% in comparison with the previously explained case. In addition to shortening the read-out duration, the SPI module according to the invention thus also makes it possible to make more efficient use of the computing power in a microcontroller that drives the SPI module during operation.

### LIST OF REFERENCE SYMBOLS

10 SPI module
20 Microcontroller
ta Activation period
tp Activation pause
DI Command input
DO Serial data output
111-11n Data inputs
SD1-SDN Data
CS1 First chip select input
CS2 Second chip select input
CS Chip select input
CLK_SPI Clock input

1-6. (canceled)

7. A serial/parallel interface module comprising:
a plurality of parallel inputs for supplying data;
a memory arrangement for storing supplied data, a serial command input and a serial data output; and
wherein upon receipt of a read signal of a first type, the module provides a plurality of data blocks of a predetermined length in direct succession at the serial data output.

8. The module of claim 7, comprising:
wherein the module is configured to provide one data block of the predetermined data length at the serial data output upon receipt of a read signal of a second type at the serial command input.

9. The module of claim 8, comprising:
a separate input for supplying the first read signal.

10. The module of claim 7, comprising:
a separate input for supplying the first read signal.

11. The module of claim 7, comprising wherein the module is configured to set the number of data blocks which are output in direct succession using the read signal of the second type.

12. A method for reading out data from a serial/parallel interface module
comprising: providing a plurality of parallel inputs for supplying data;
providing a memory arrangement for storing supplied data, a serial command input and a serial data output;
receiving a read signal of a first type; and
reading out a plurality of data blocks of a predetermined length in direct succession at the serial output in response to the read signal of the first type.

13. The method of claim 12, comprising:
receiving a read signal of a second type;
reading out one data block of the predetermined data length at the serial output in response to the read signal of the second type.

14. The method of claim 13, comprising:
using the read signal of the second type to set the number of data blocks which are output in direct succession.

15. A serial/parallel interface module comprising:
a plurality of parallel inputs for supplying data;
means for storing supplied data, a serial command input and a serial data output; and
wherein upon receipt of a read signal of a first type, the module provides a plurality of data blocks of a predetermined length in direct succession at the serial data output.

16. The module of claim 15, comprising:
wherein the module is configured to provide one data block of the predetermined data length at the serial data output upon receipt of a read signal of a second type at the serial command input.

17. A serial/parallel interface module system comprising:
a plurality of parallel inputs for supplying data;
a memory arrangement for storing supplied data, a serial command input and a serial data output; and
a microcontroller, wherein upon receipt of a single read signal of a first type, the module provides a plurality of data blocks of a predetermined length in direct succession at the serial data output to the microcontroller.

18. The system of claim 17, comprising:
wherein the module is configured to provide one data block of the predetermined data length at the serial data output upon receipt of a read signal of a second type at the serial command input.

19. The system of claim 18, comprising:
a separate input for supplying the first read signal.

20. The system of claim 18, comprising wherein the system is configured to set the number of data blocks which are output in direct succession using the read signal of the second type.

21. The system of claim 17, comprising:
a sensor coupled to one of the plurality of parallel inputs for providing sensor data, wherein the supplied data is the sensor data.

22. The system of claim 17, comprising:
a chip select input coupled to a chip select output on the microcontroller.

23. A vehicle sensor system comprising:
one or more vehicle sensors for providing sensor data;
a serial/parallel interface module having a plurality of parallel inputs for receiving the sensor data, a memory arrangement for storing the sensor data, a serial command input and a serial data output; and
a microcontroller, wherein upon receipt of a single read signal of a first type, the serial/parallel interface module provides a plurality of data blocks of a predetermined length in direct succession at the serial data output to the microcontroller, and wherein the microcontroller is configured to evaluate the sensor data.

24. The system of claim 12, comprising:
wherein the module is configured to provide one data block of the predetermined data length at the serial data output upon receipt of a read signal of a second type at the serial command input.

25. The system of claim 24, comprising:
a separate input for supplying the first read signal.

26. The system of claim 24, comprising wherein the system is configured to set the number of data blocks which are output in direct succession using the read signal of the second type.

27. The system of claim 23, comprising:
an occupant protection system, where upon evaluating the sensor data, an output signal is provided to the occupant protection system.

28. The system of claim 23, wherein the sensor data includes pressure data.

29. The system of claim 23, wherein the sensor data includes acceleration data.
